(19) United States
(12) Patent Application Publication
(10) Pub. No.: US 2026/0073210 A1
(43) Pub. Date: Mar. 12, 2026

(54) FLEXIBLE AND EFFICIENT NEURAL EMBEDDINGS FOR SCALING TOLERANT REPROGRAMMABLE ANALOG

(71) Applicant: ASPINITY, INC., PITTSBURGH, PA (US)

(72) Inventor: Brandon David RUMBERG, Pittsburgh, PA (US)

(21) Appl. No.: 19/323,154

(22) Filed: Sep. 9, 2025

Related U.S. Application Data
(60) Provisional application No. 63/692,266, filed on Sep. 9, 2024.

(51) Int. Cl. G06N 3/065; G06N 3/0464

(52) U.S. Cl. CPC G06N 3/065; G06N 3/0464

(57) ABSTRACT

Systems, methods and computer program code are provided to compile a model for execution on an analog neural processing unit (NPU) and to operate an analog NPU.

### RELATED APPLICATIONS

This application is based on, and claims benefit of and priority to, U.S. Provisional Application Ser. No. 63/692,266 filed on Sep. 9, 2024, the contents of which are hereby incorporated herein by reference in their entirety for all purposes.

### BACKGROUND

All-digital computation is the norm in commercial artificial intelligence (“AI”) hardware, with scaling to large model sizes possible due to the robust nature of digital processing. However, inefficiencies arise both from the multiply-and-accumulate (“MAC”) circuitry used in matrix multiplication (which is costly in terms of power consumption and area) and also data movement to/from memory (which is costly in terms of power consumption and latency). Emerging and research-grade technologies aim to improve efficiency of the MAC function, reduce the costly movement of data/weights, and perform processing near the sensor. For example, analog in-memory-compute techniques utilize memory arrays storing model parameters as crossbar networks to significantly reduce the cost of a MAC by never fetching the model parameters, only the result of the MAC is fetched from the memory. This technique may reduce the von Neumann bottleneck with regard to parameter memory fetches, but significant inefficiencies still exist with the continual conversion between the analog and digital domains as well as the storage of inter-layer computation results. Additionally, crossbar arrays using nonvolatile memory as the multipliers are beholden to the variability and nonlinearities of the memory elements, which can significantly limit the performance of a neural network (“NN”).

These limitations of all-digital computation and analog in-memory-compute techniques make it difficult to implement NNs in edge devices, particularly in battery-powered devices.

It would be desirable to provide low-power, large-scale neural-network hardware and to enable large-scale all-analog NNs. It would also be desirable to provide ultra-efficient processing of raw sensor information to provide actionable insights for use in those NNs.

### BRIEF DESCRIPTION OF THE DRAWINGS

Features and advantages of the example embodiments, and the manner in which the same are accomplished, will become more readily apparent with reference to the following detailed description while taken in conjunction with the accompanying drawings.

FIG. 1 is a system diagram of a system incorporating an analog neural processor (“NPU”) pursuant to some embodiments.

FIG. 2 is a model compilation process pursuant to some embodiments.

FIG. 3 illustrates an analog NPU integrated circuit pursuant to some embodiments.

FIG. 4 illustrates an analog NPU integrated circuit pursuant to some embodiments.

FIG. 5 illustrates mapping a conventional ResNet-like neural network architecture (top) to an analog NPU architecture pursuant to some embodiments (bottom).

FIG. 6 illustrates a configurable analog MAC array pursuant to some embodiments.

FIG. 7 illustrates the efficiency versus variation for a current mirror using halo-blocked transistors in a 22 nm process.

FIG. 8 illustrates variation-induced accuracy reduction for a system pursuant to some embodiments.

FIG. 9 illustrates a neural network data path with error adaptation feedback pursuant to some embodiments.

FIG. 10 illustrates an architecture pursuant to some embodiments for local layer adaptation.

FIG. 11 illustrates temperature compensation within a network pursuant to some embodiments.

FIG. 12 illustrates an analog imaging system integration pursuant to some embodiments.

FIG. 13 illustrates analog front-end circuitry interfaced to a passive pixel sensor pursuant to some embodiments.

FIG. 14 illustrates a hardware demonstrator and user API pursuant to some embodiments.

FIG. 15 illustrates model compression and decoding processing pursuant to some embodiments.

FIGS. 16A-D illustrate a global adaptation process pursuant to some embodiments Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments provide a variation-tolerant analog neural processor and model compilation process that enables end-to-end analog processing to eliminate costly analog-to-digital conversions. Embodiments utilize pipelined vector convolution for fused NN operations, substantially reducing data movement (e.g., to less than 2% of the energy budget of the processor). Further, embodiments utilize multi-level programmable error adaptation to tolerate process variations with minimal overhead. The overall energy budget is significantly less than traditional digital AI hardware, and the process variations are significantly fewer than analog in-memory compute techniques.

Pursuant to some embodiments, systems, methods and computer program code are provided which include a variation-tolerant analog Neural Processing Unit (“NPU”) to achieve orders-of-magnitude power efficiency gains. Systems pursuant to the present invention include an efficient pipelined vector convolution architecture. Pursuant to some embodiments, an NPU programmable structure implementing features of the present invention will enable the model compiler to reduce intermediate caching by fusing many neural network (“NN”) operations per data vector read/write, allowing the architecture to scale to 100 M on-chip parameter NNs with minimal data movement overhead in the energy budget and larger NNs with off-chip memory. Embodiments include a high degree of compensation programmability to support new algorithmic approaches, improving efficiency and tolerance to process, voltage and temperature (“PVT”). This programmability enables the model compiler to program the most efficient run-time adaptation routine that maintains model evaluation robustness. Pursuant to some embodiments, the NPU's parameters are compressed for efficient run-time decoding. This parameter compression reduces the weight-buffering energy and area cost of large models so that the architecture scales efficiently.

Embodiments allow the robust analog NN encodings and model-informed adaptation to achieve <N % degradation (defined at compilation as an energy/accuracy tradeoff) in large deep neural networks (“DNNs”) and minimal impact to the energy budget. Pursuant to some embodiments, systems of the present invention encode error correction/fault tolerance into the NN model allowing the model compiler to insert robustness into the layers that are most sensitive to errors.

Pursuant to some embodiments, adversarial error adaptation is trained at compilation time and evaluated at run time. Embodiments of the present invention incorporate algorithmic definition of global feedback, in which the model compiler uses PVT statistics and training data to train a feedback loop that runs periodically in the architecture's programmable error adaptation to provide a final layer of robustness. Embodiments may improve state-of-the-art NPU efficiency by orders of magnitude while maintaining software-equivalent accuracy in large-scale analog NN models, transforming the distribution of intelligence across edge computing infrastructure. Embodiments establish an algorithmic path to achieve higher yields and efficiencies in general analog circuits.

Embodiments bring analog's time-series processing efficiency to more general large-scale model evaluation. In both general-purpose analog accelerators and analog compute-in-memory accelerators, it is assumed the data is a digital input and that various steps to acquire, prepare, and frame the data have already taken place. Embodiments avoid these inefficiencies with a lightweight analog front-end and minimal preprocessing before running the model.

Explorations on large-scale analog compute-in-memory have studied the effects of conductance variation, drift, and noise on model accuracy-the projected ability to recover software-level accuracy are encouraging but have relied on compute-intensive hardware-aware (or hardware-in-the-loop) training and run-time digital compensation steps.

Embodiments focus on low-overhead software-level accuracy by adding programmable error adaptation to the architecture and multi-step compilation to define the required adaptation and model retraining for a given model. In general, embodiments may provide a direct-to-analog-image-sensor analog NPU that runs large-scale models at orders-of-magnitude efficiency improvement beyond the state of the art.

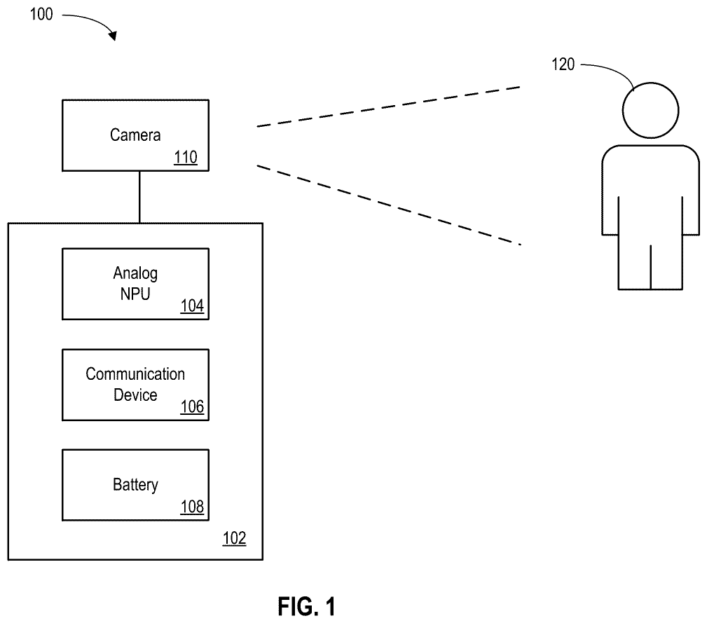

Embodiments may be used in a number of different applications and achieve particularly desirable results when used in environments where power consumption is a concern. To illustrate features of some embodiments, an illustrative (but not limiting) example will be provided by reference to FIG. 1, where a detection system 100 is shown that includes a battery-powered alarm system 102 is shown that is designed for low-energy surveillance. Pursuant to some embodiments, an analog NPU 104 pursuant to the present invention serves as the core AI accelerator, enabling always-on person detection from images captured by a low-resolution camera 110. This implementation leverages the analog NPU's ultra-efficient end-to-end analog architecture to process raw sensor data without power-intensive digital conversions, achieving sub-milliwatt operation for months-long battery life in remote or portable setups, such as home security devices or wildlife monitors. The system 102 may include a communications device 106 to transmit alerts or other information to a remote monitoring system (not shown).

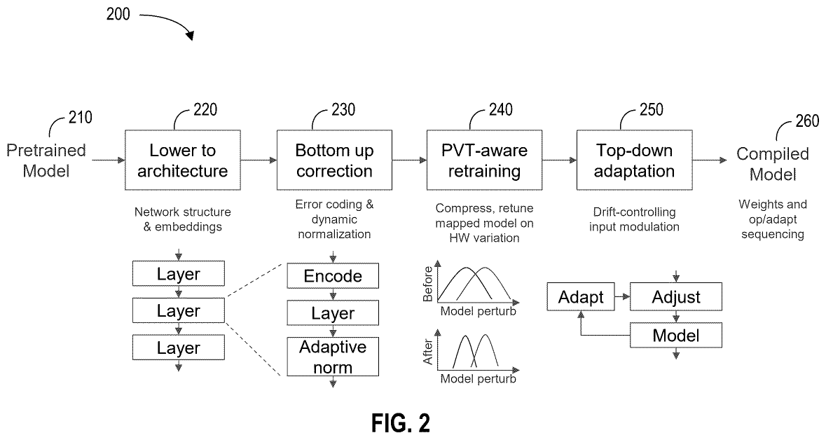

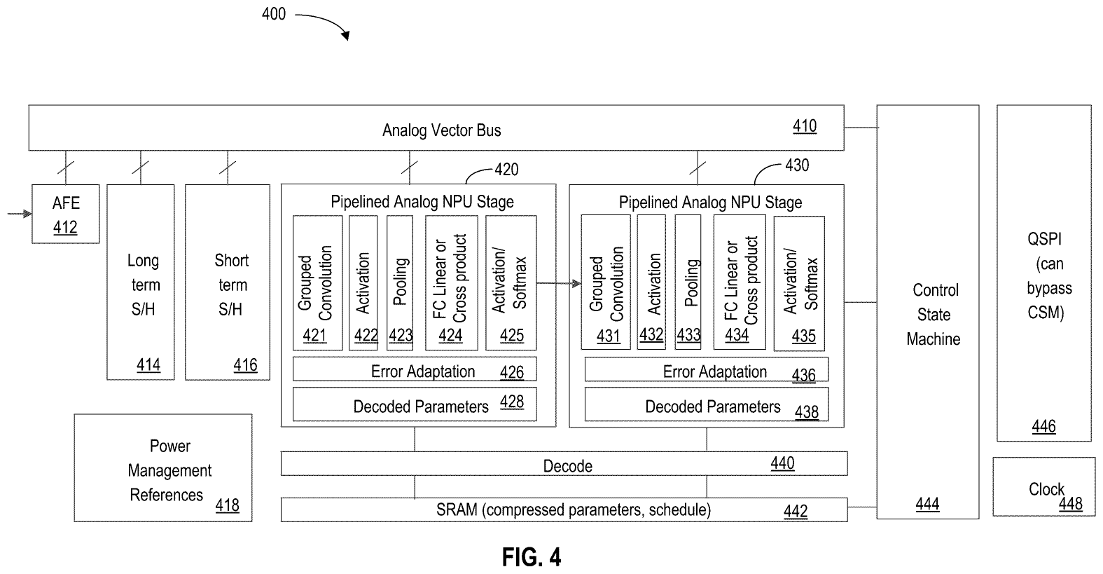

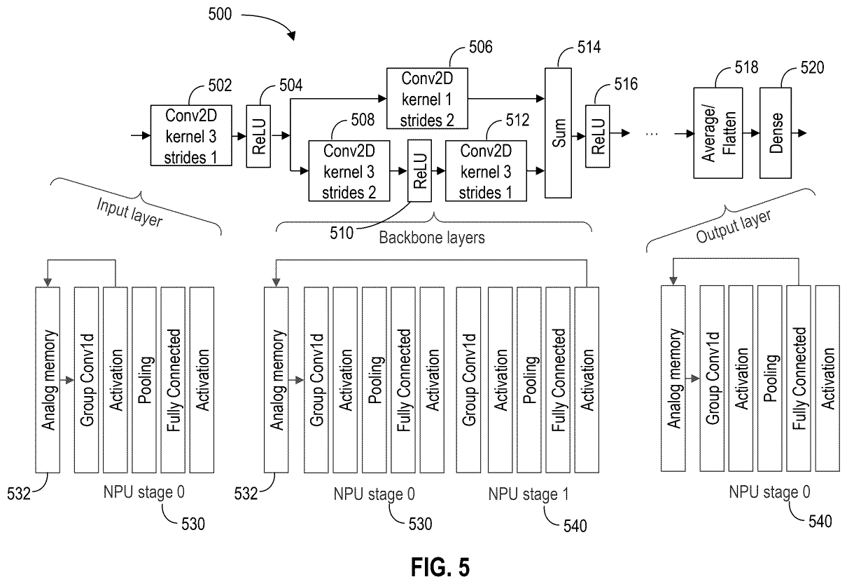

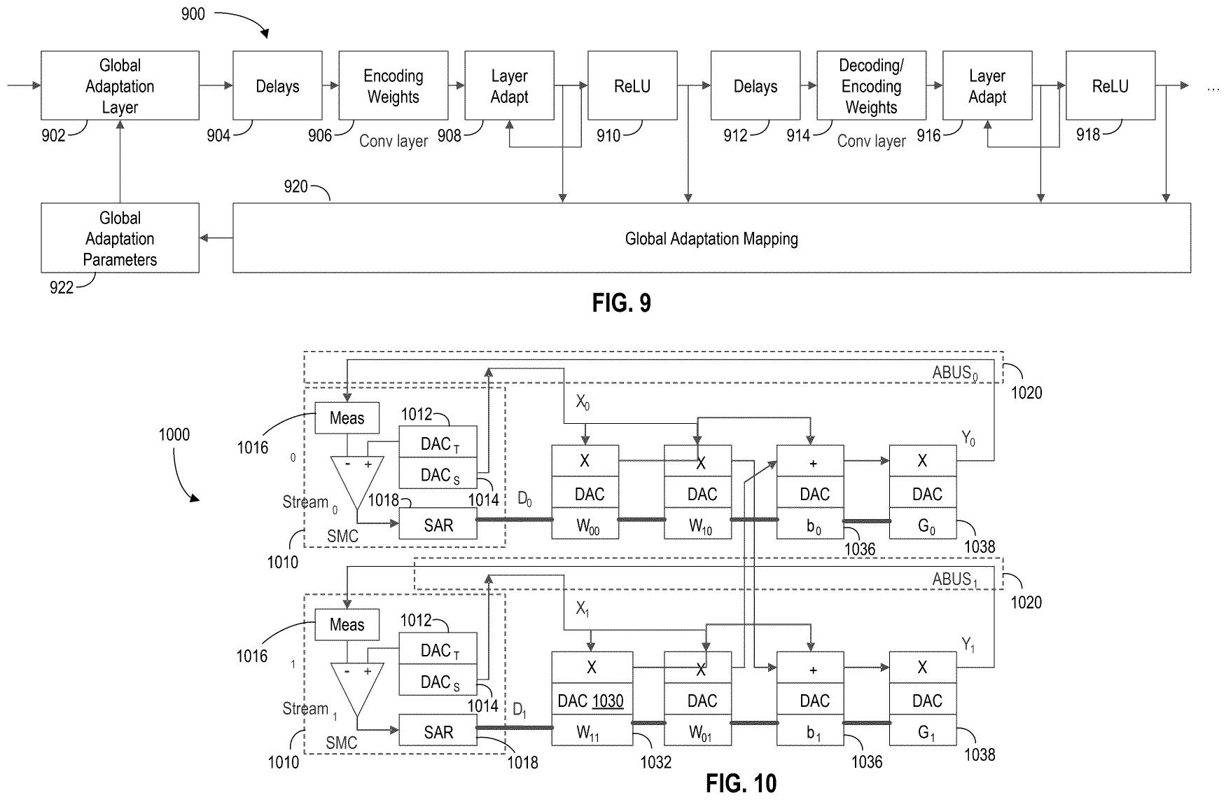

As will be described further herein, the analog NPU 104 is programmed via a multi-step model compilation process (as illustrated in FIG. 2) starting from a pre-trained digital neural network, such as, for example, a lightweight ResNet convolutional neural network (CNN) variant optimized for binary classification: “person present” vs. “no person.” The compilation process lowers the model graph to the analog NPU's pipelined structure (as shown in FIGS. 4 and 5), fusing operations like Conv2D convolutions, ReLU activations, and pooling into 1D temporal convolutions for efficient vector streaming. Error-correcting encodings and adaptive normalization are inserted during bottom-up correction to tolerate hardware variations (e.g., PVT-induced mismatches up to 20%, as shown in FIG. 8), with PVT-aware retraining and global adaptation loops (as shown in FIG. 9) ensuring <N % accuracy loss despite temperature drift or device aging. The compiled model, compressed up to 30× via pruning and quantization, is loaded into the analog NPU's SRAM buffers for on-the-fly decoding into shadow registers.

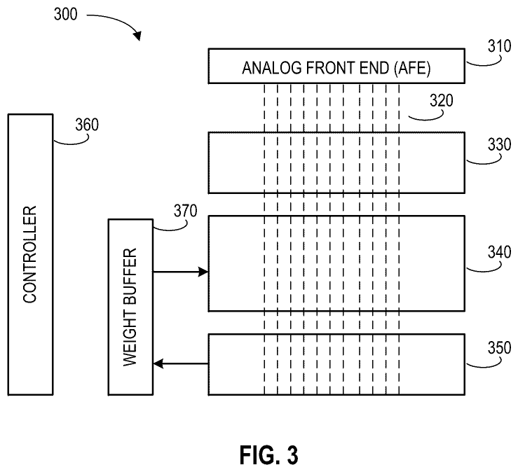

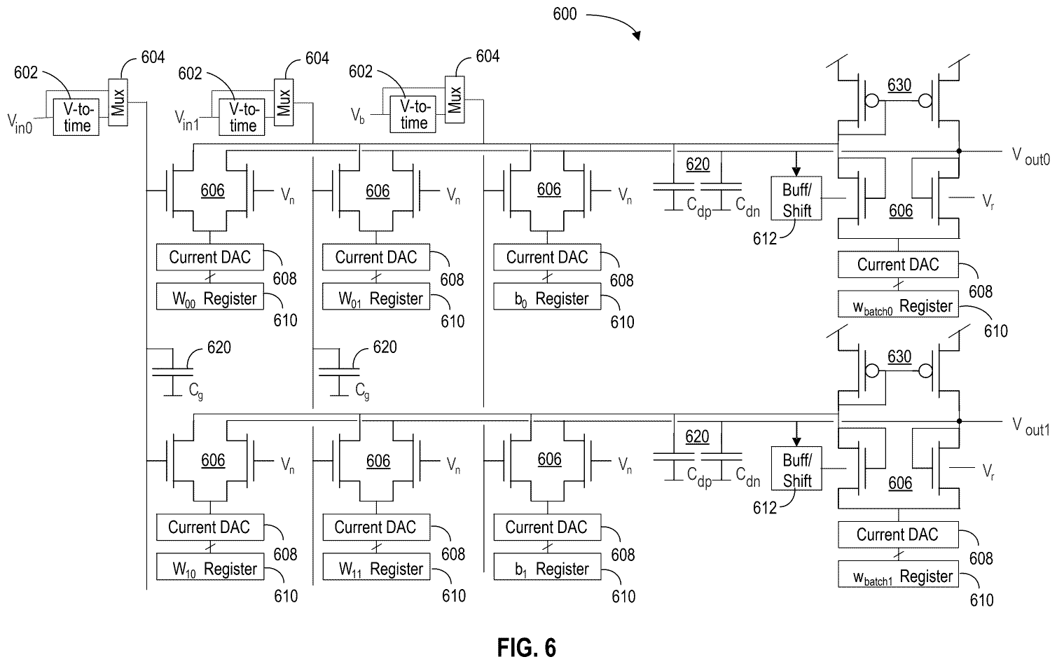

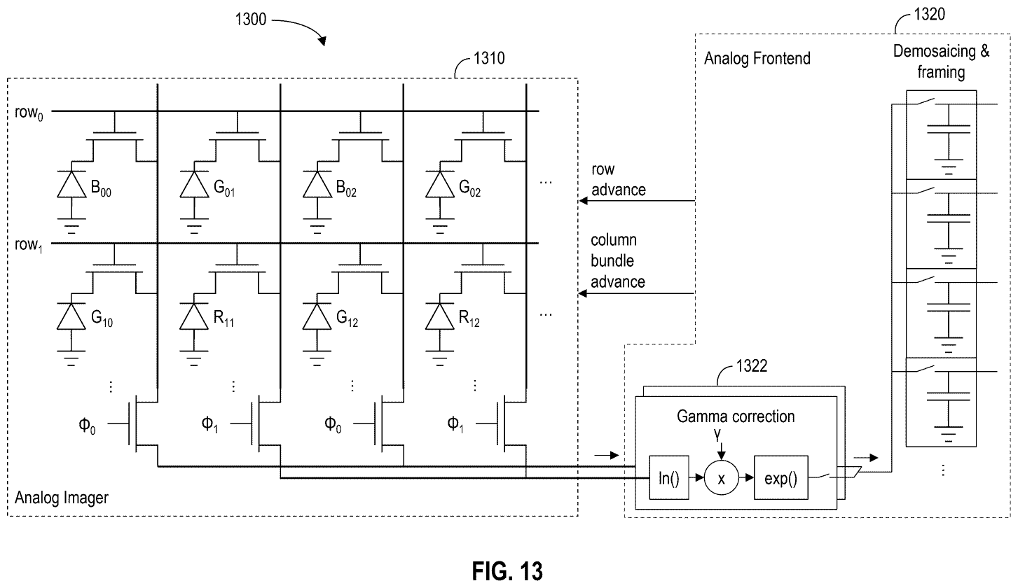

During operation, raw camera images (from camera 110) enter into an analog front-end of the analog NPU 104 (shown as the “AFE” in FIGS. 3 and 13), which applies gamma correction and demosaicing to frame pixel values into multi-element analog vectors (e.g., 24 elements with 3 RGB channels×8 rows). The pixel values may have been digitized by the camera 110 or may be raw analog pixel currents/voltages. These vectors stream via a full-duplex analog vector bus (shown in FIGS. 3 and 4) into short-term sample-and-hold buffers, where a two-stage pipelined analog NPU processes them (although a two-stage pipeline is shown in some of the examples herein, multiple pipeline stages may be provided). As will be described further below, the stages ping-pong between operations, e.g. Stage 0 may perform input layer embedding and initial convolutions to extract features like edges and shapes, Stage 1 may then handle backbone layers for deeper feature fusion, and then Stage 0 may perform output layer flattening to produce class probabilities (e.g., out of 2 classes). A configurable MAC array (shown in FIG. 6) computes dot-products in transconductance-ratioing mode for 13× efficiency gains. Layer-level adaptation (as shown in FIG. 10) periodically trims gains/offsets using Stimulate-Measure-Control blocks, while global adaptation (shown in FIG. 9) modulates inputs for drift compensation.

If the analog NPU 104 detects a person 120, the analog NPU 104 may trigger an alarm signal (e.g., via a simple digital interface with a communications device 106. This setup delivers software-equivalent accuracy on benchmarks like custom person detection datasets, with an energy budget of ˜0.1 fJ/op, making it ideal for battery-constrained environments where traditional digital NPUs would drain power rapidly. Those skilled in the art, upon reading this disclosure, will appreciate that this is but one example of the use of an analog NPU pursuant to the present invention.

Embodiments achieve these results through a flexible, multi-level approach that is unified by a system architecture 300 (shown in FIG. 3 and discussed below) and a model compilation process 200 illustrated in FIG. 2. The model compilation process 200 has similarities to existing digital model compilation (such as model lowering to best utilize the hardware resources and retraining to recover accuracy after model compression) but also optimizes over a mixture of error correction techniques (for PVT and drift errors) to suit the model, accuracy tolerance, and energy budget. The model compilation process 200 provides efficient and variation-tolerant model deployments. As shown in FIG. 2, the model compilation process 200 starts at 210 with a pretrained model. For example, the pretrained model may be an input NN such as a pre-trained convolutional neural network (“CNN”) from frameworks like PyTorch or TensorFlow, trained on datasets such as CIFAR-10 or ImageNet or the like.

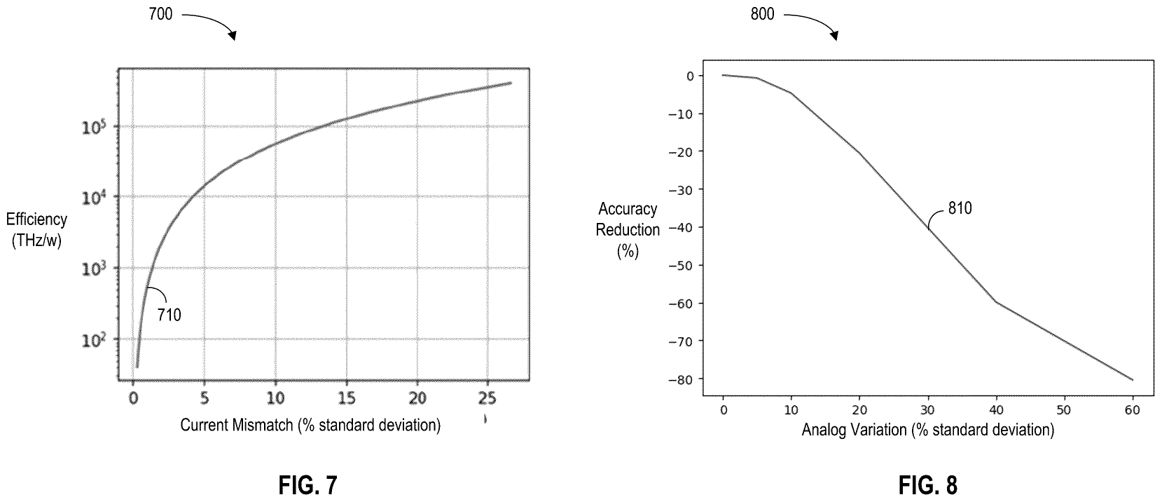

The model compilation process 200 continues at 220 where a lower to architecture processing step is performed. During graph lowering, model operations are fused or decomposed to best utilize hardware resources. Processing at 220 is an initial “graph lowering” step, where the high-level model graph (from the pretrained model 210) is transformed to match the analog hardware of the present invention. Processing at 220 includes fusing operations (e.g., combining Conv2D and ReLU into a single pass) or decomposing operations (e.g., 2D convolutions to 1D temporal convolutions for vector streaming) to optimize for the analog NPUs 104 pipelined structure (which will be described further below in conjunction with FIGS. 4 and 5). The embeddings referred to in step 220 of FIG. 2 are initial input processing, such as patch embedding for image data. Processing at 220 includes the generation of a layered structure, where each layer is adapted for hardware efficiency (e.g., fusing multiple operations to reduce data movement between short term buffers). Processing at 220 results in transformation of the model to ensure the model utilizes hardware resources (like an analog vector bus) effectively. This is similar to digital compilers but tailored for analog constraints (e.g., no digital memory fetches). The output of 220 is a hardware-optimized graph ready for further processing at 230. Processing at 230 includes bottom-up correction processing to perform dynamic error coding and normalization. Layer-level variation is reduced with matmul-mapped error coding and local adaption loops. For example, processing at 230 may include the application of matmul-mapped error coding (e.g., inserting redundant codes into matrix multiplications for fault tolerance) and application of local adaptation loops (e.g., batch normalization to handle PVT variations). This mitigates errors like transistor mismatches early in the stack. Processing at 230 includes encoding to encode layers with error-correcting techniques (e.g., such as Lipschitz regularization or redundant residue number systems), to bound error propagation without retraining the entire model. Processing at 230 also includes layer processing to process individual NN layers sensitive to variations (e.g., such as convolutional layers in CNNs). Processing at 230 also includes adaptive normalization processing (e.g., pushing activations away from zero to avoid ReLU discontinuities under noise). In general, processing at 230 reduces layer-level variations (e.g., as shown in FIG. 7 for accuracy degradation) with low overhead, preparing the model for hardware perturbations.

Processing continues at 240 where PVT-aware retraining is performed. This processing includes compressing and re-tuning the model for the variation statistics of the specific architecture it will run on. Processing at 240 may include model compression (e.g., pruning and quantization for up to 30× reduction in parameters) to lower weight-buffering energy. Model compression reduces weight buffer energy. Limited retraining recovers systematic accuracy loss from preceding steps and incorporates residual error statistics from 230 to improve resilience to hardware perturbations. Model perturbation may be performed to inject perturbations (e.g., noise from variation, drift) during limited retraining to recover accuracy from prior steps. The result of processing at 240 ensures the compressed model maintains user's desired software-equivalent accuracy (with less than N % degradation) by optimizing over error correction techniques suited to the model's tolerance and energy budget.

Processing continues at 250 where top-down adaptation is performed. Processing at 250 includes drift controlling input modulation using a periodic global adaptation loop that monitors model errors (e.g., using PVT statistics and training data) and adjusting inputs to compensate for long-term drift or nonidealities. A periodic global adaptation loop monitors model errors and adjusts inputs to compensate. In some embodiments, this may be performed by offline training with adversarial reprogramming. Processing may output adjusted parameters (e.g., input modulation via a compensating adaptation layer) for runtime evaluation. The loop, in some embodiments, runs rarely to minimize energy consumption (e.g., the local loop may only run at load time and the global may only run once per day). This final compilation step sequences drift control, ensuring robustness across the entire NN, and integrates with the prior process steps by refining the refined model. The compiled model is output at 260 (including weights, adaptation parameters, and controller sequences). The compiled model may then be stored compressed in SRAM or other memory for efficient decoding.

The compiled model may then be installed or configured on the analog NPU 104 for use. Reference is now made to FIG. 3 where a block diagram depicts functional components of an analog NPU 300 pursuant to some embodiments. In general, the analog NPU 300 architecture features a wide vector data bus backed by short-term feature buffering. The analog vector NPU 300 can pipeline temporal convolution and multiple layers to minimize data movement energy. A programmable error adaptation block performs layer-level normalization and global error measurement to adjust inputs for drift or other nonidealities. The analog NPU 300 includes an analog front end (“AFE”) 310 which allows the analog NPU 300 to interface with one or more sensors (e.g., for gamma correction and demosaicing as shown in FIG. 13). The analog NPU 300 also includes a vector data bus 320, an analog feature buffer 330, a pipelined analog vector NPU 340, an error adaption component 350, a controller 360, and a weight buffer 370. The vector data bus 320 provides a wide, full-duplex analog bus (e.g., 32 elements) for routing vectors, minimizing data movement. The analog feature buffer 330 includes short term sample-and-hold (“S/H”) buffers for caching features, enabling pipelining as described herein. The pipelined analog NPU 340 includes a two-stage NPU for temporal convolution and fused layers (for example, Conv ID and ReLU, as shown in FIG. 5). The pipelined analog NPU 340 includes MAC arrays (as shown in FIG. 6) for efficient computation. The error adaption component 350 includes a programmable block for layer-level normalization and global error measurement (e.g., such as the SMC shown in FIG. 10), adjusting for drift. The controller 360 is a digital control mechanism that orchestrates the overall inference workflow and adaptation routines. The weight buffer 370 is a compressed storage element that holds the model's parameters (e.g., weights, biases, and adaptation data) post compilation (e.g., the compiled model 260 produced by the process 200 of FIG. 2). Further details of these components and the structure of an analog NPU pursuant to the present invention will be described in further detail below. In general, the components of FIG. 3 enable the analog NPU 300 to achieve significant efficiency gains over digital counterparts by optimizing parameter handling and control in a variation-tolerant manner.

Features of some embodiments are shown in the analog NPU 400 integrated circuit architecture depicted in FIG. 4. In particular, the architecture of the present invention shown in FIG. 4 includes an analog data path which is linked by an analog vector bus 400, which routes analog vectors full-duplex. A typical inference may consist of routing sensor data from an AFE 412 through a pipelined analog NPU stage 420, 430 to “patch embed” and store as vectors in a short-term sample and hold (“S/H”) analog cache 416. The vectors are then streamed through the pipelined analog NPU stages 420, 430 with multiple operations fused in a single pass with the resulting vectors streamed back to a S/H analog cache 414, 416. The steps are repeated for each layer, decompressing model parameters as needed. Error adaptation is performed according to the compiled model. A long-term S/H analog cache 414 provides extended caching for full input data (e.g., such as full images). It supports buffering raw or preprocessed vectors from the AFE 412 allowing the analog NPU 400 to handle larger datasets or time-series inputs.

Computationally, the architecture centers around the pipelined analog NPU stages 420, 430. These pipelined analog NPU stages 420, 430 contain highly parallel reconfigurable analog blocks that can be tiled to achieve different performance objectives. Most of the computational power is in the grouped convolution 421, 431 (delays and MACs) and fully-connected layers 424, 434. The temporal grouped convolution can run 1D convolution (Conv1d) or mimic 2D convolution (Conv2d) with an in-place kernel. Each pipelined analog NPU stage 420, 430 also contains a pooling layer 423, 433 and multiple activation layers 422, 432 which support ReLU, sigmoid, and tanh. An activation/softmax component 424 provides final activation for classification (e.g., such as softmax for probabilities). The configurability allows multiple operations and layers to be fused together for less data movement. All-in-all, the operations per read/write can be reduced by >5× versus traditional matrix-multiply or Conv2d oriented accelerators. Each pipelined analog NPU stage 420, 430 also incorporates the low-overhead programmable error adaptation 426, 436 capabilities discussed in FIG. 2.

Vectors stream through the pipelined analog NPU stages 420, 430 via the analog vector bus 410, typically making round trips from and back to the short-term S/H analog caching 416, which stores the feature maps in between fused layer evaluations. Vectors are only stored in the short-term S/H analog cache 416 for <10 μs so that leakage has a small impact. The pipelined analog NPU stages 420, 430 are time-multiplexed, with a control state machine 444 reconfiguring the stages 420, 430 from layer configurations that are stored in a memory (shown as SRAM 442). Weight fetch overhead is reduced via fused layers and via a compressed representation such that fewer bits are fetched per weight. The control state machine 444 also inserts error adaptation operations 426, 436 as required.

The data path can achieve significant efficiency levels without requiring pruning or other optimizations to reduce the required computation thanks in part to the weight buffers 428/438 and movement shown in FIG. 4. Therefore, the energy to configure layers may limit the overall efficiency. Pursuant to some embodiments, all analog parameters in the NPU are digitally controlled and backed by multiple digital registers 610 for rapid and efficient switching. Meanwhile, weights are stored compressed in a larger SRAM bank 442 to minimize the energy of fetching from a larger bank. Local and global error adaptation loops run rarely to minimize energy. To avoid the memory read cost of fetching the entire model each time an inference runs, compression may be applied to the model, which reduces the readout requirements by decoding the parameters 440 on the fly. Standard model compression techniques of pruning and quantization can compress the model by 30×.

Additional efficiency gains may be achieved by dynamically avoiding unnecessary parts of the model based on what has been run, by optimizing VDD, or with a memory array that locally decodes to analog values that are transferred on fewer bit lines or distributing the compressed model throughout the NPU so that less parameter movement is required.

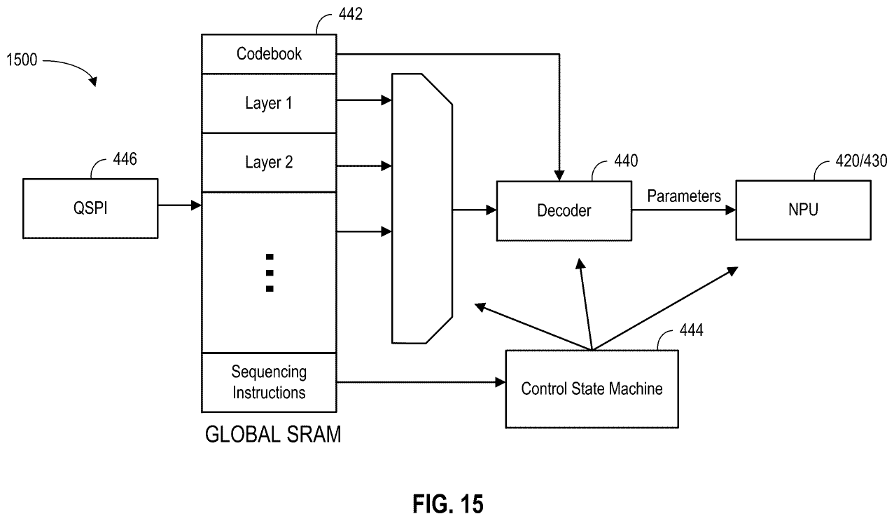

Referring now to FIG. 15, further details of the model compression and decoding processing 1500 are shown. Processing 1500 includes loading the compiled model into SRAM 442 via an interface such as a quad serial peripheral interface (“QSPI”) 446. In some embodiments, the compiled model includes a codebook for decoding the compressed layers. The compressed layers are stored in blocks such that they can be parallely read and decoded and applied to the NPU 420/430 registers without scanning sequentially through the SRAM 442 or sequentially through NPU registers. A portion of SRAM 442 stores sequencing instructions that tell the control state machine 444 how to sequence all of the operations to dynamically run through the model and apply trimming operations.

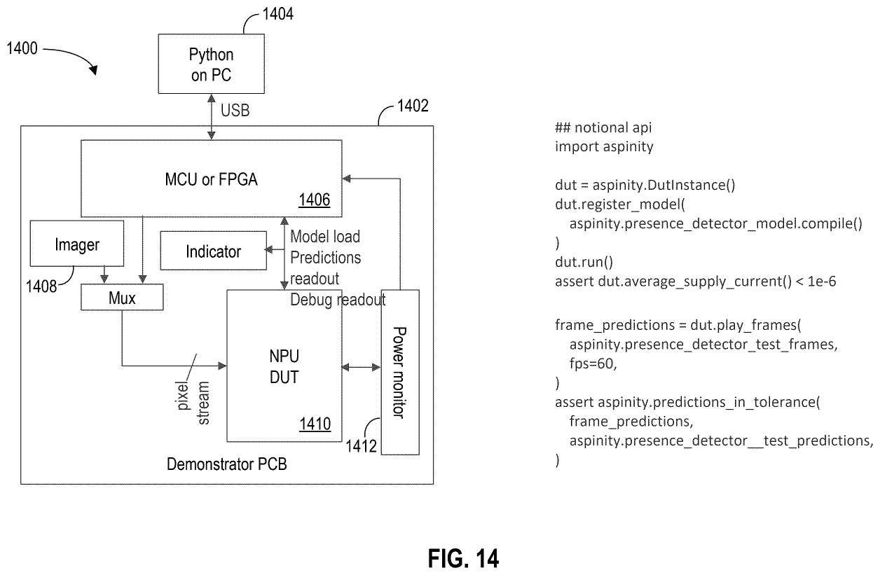

Referring again to FIG. 4, the quad serial peripheral interface (“QSPI”) 446 may be provided for external model loading or debugging (e.g., such as via a USB interface as shown in the demonstrator depicted in FIG. 14). A clock 448 provides timing signals for synchronous elements, supporting variable speeds for energy optimization. A power management references module 418 generates stable voltage and current references for the analog blocks, enabling subthreshold operation and variation tolerance (e.g., such as for the halo blocked transistors shown in FIG. 6).

Pursuant to some embodiments, a DNN can be mapped into the analog NPU architecture of the present invention. For example, a typical DNN with ResNet backbone can map into the analog NPU of the present invention as shown in FIG. 5. The sequence proceeds from after the input image has been buffered into the Analog Memory (short-term <10 μs S/H feature map caching), then the NPU is configured to perform different fused sets of operations.

Pursuant to some embodiments, a single NPU stage is configured to run a Conv2D followed by ReLU activation. The image is streamed from an analog memory 532 through the NPU as 24-element vectors containing 3 colors for 8 rows. The Conv2D weights are mapped onto the NPU's Conv ID operation such that the temporal convolution is across image columns and row x channel are input channels to the Conv1D. Activation is applied before routing the results back to the analog memory 532. The first layer projects up to a higher number of channels (16) by toggling between parameters for each vector input, writing more output vectors than input vectors. All of those weights are loaded together into shadow registers in the NPU when the layer is configured.

Repeating backbone layers composed of operations 505, 506, 510, 512, 514, 516 may be mapped as follows. The similarity between the backbone network topology and the hardware target allow many of the operations and layers to be fused such that they can all run in a single pass from the analog memory 532 and back. The whole backbone topology is statically mapped onto the two NPU stages and all of the embeddings from the previous layer are streamed through to obtain the inputs to the next layers. In a deep NN, each backbone structure is sequenced through by updating the parameters in the NPU stages once the embeddings have all been processed. Then the process starts again. A deeper 1D kernel is used to process across the increased number of channels since the channel x row product is too much for a 32-element bus. This continues through the rest of the layers.

The final, or output layer flattens the data and projects down to the class encoding. The final fully-connected layer may be decomposed into multiple matrices with the weights loaded at configuration time and toggled through as it runs.

For the dominant computational workload, analog matrix multiplication, embodiments utilize the matrix configuration in FIG. 6. The matrix configuration of FIG. 6 depicts a configurable analog MAC array 600 pursuant to some embodiments. The transconductance-ratioing circuitry is notional with additional transistors required on the input and output converters to extend the range. This analog MAC array 600 can operate in a high-speed transconductance-ratioing mode or a more conventional pulse-integration mode. In the transconductance-ratioing mode, the V-to-time converter 602 is skipped, and the analog voltage is applied directly as the input to the array of differential pairs 606. Weights are stored in registers 610 and the sign of the weight is modified by swapping the gate/drain combination of the differential pair 606. Positive and negative currents are accumulated across a dot-product row and a wide-linear range current-to-voltage converter 608 converts the differential currents to a voltage. The transconductance of the converter 608 is utilized to adapt the batch scaling. In a conventional pulse-integration mode, the V-to-time converter 602 drives the inputs, Vₙ is grounded so the differential pair 606 acts as a switch and the pulsed currents are integrated on C_{dp} and read out. The transconductance-ratioing mode is more efficient by a factor of 13πVDD/4 for the same capacitance value. The primary disadvantage of transconductance-ratioing mode is that it has more power gating overhead whereas the integration mode is naturally power gated so the integration mode is included for scenarios that have few operation cycles per layer configuration.

As shown in FIG. 6, two streams are shown (a top stream and a bottom stream). The top stream computes for Vₒᵤₜ₀ and the bottom stream computes for Vₒᵤₜ₁. For example, the Woo register 610 and current DAC 608 stores and converts weight Woo to current for multiplication with Vᵢₙ₁. The W₀₁ register 610 and current DAC 608 handles weight W₀₁ for Vᵢₙ₁. The b₀ register 610 and current DAC 608 bias b₀ and add to the accumulation. The W_{batch0} register 610 and current DAC 608 weight the batch (e.g., for normalizations or grouped convolutions). The capacitors 620 C_{dp} and C_{dn} provide positive and negative current direction controls, enabling signed operations or variation compensation. The bottom stream (the Vₒᵤₜ₁ path) includes a W₁₀ register 610 and current DAC 608 which provide a weight W₁₀ for Vᵢₙ₀, etc. The capacitors 620 C_{dp} and C_{dn} are symmetric with the top stream for signed/differential handling. The DACs 608 output currents proportional to weights, which are ratioed against the inputs (Vᵢₙ) in transconductance mode.

The output blocks (shown on the right-hand side of the figure) include Vᵣ (a reference voltage) fed into buffer/shift blocks 612 to condition the accumulated voltages (e.g., to amplify or level shift Vₒᵤₜ₀ and Vₒᵤₜ₁) before feeding back to terminate the analog bus. Each input includes a Voltage-to-time converter 602 and a multiplexer 604 to select whether to convert analog voltages to time-domain signals for optional pulse integration mode.

Errors caused by PVT and long-term drift are key technical challenges for large-scale analog neural networks. Core analog compute operations exhibit an efficiency versus variation tradeoff as shown in FIG. 7. To achieve the highest levels of efficiency, operations varying >5% standard deviation will pervade the data path. Error sensitivity is exacerbated in deep neural networks, especially CNNs. Hardware-in-the-loop training and exhaustive parameter trimming are infeasible for large deployments.

Prior work on large-scale analog NNs has taken a variety of approaches to error tolerance. Generally such systems utilize novel memory technologies for compute-in-memory (CIM) and have inherent errors in the computations. And generally such systems accept and characterize nonidealities to be handled algorithmically. Systems using nonvolatile memories have focused on cell-to-cell and array-to-array variation, analog programming accuracy, read disturbance, crossbar resistance, temperature, drift, and noise and generally accomplish this using variation-aware retraining to inject noise onto the weights. But significant variation-aware training is a burden for deployment, and it is unclear how generally it applies across all possible models for a given device. CIM systems sometimes describe a “full precision guarantee” wherein the analog matrix-multiplication is more precise than the bitline ADC so no accuracy is lost. However, studies on NVM-CIM accuracy tradeoffs for a ResNet-50 CNN architecture on the ImageNet dataset have found that the ADC resolution need not match the dot product bit width and that the accuracy of the dot product was more important than the accuracy of individual weights. Studies have also shown that periodic batch recalibration can mitigate the impact of phase-change memory (PCM) conductance drift and that most of the benefits of variation-aware retraining mostly arise from batch normalization, which learns to push the mean further from zero as the noise increases—presumably so parameter variation doesn't traverse the ReLU discontinuity as often. On the other hand, studies have found that large CNNs are the most variation sensitive and are unable to achieve software-equivalent accuracy purely through retraining.

Error accumulation is a concern in all-analog neural network computation without level-restoring ADC/DAC steps. Prior art has utilized analog error detect codes for vector-matrix multiplication to detected errors exceeding some analog tolerance, has applied fault-tolerance techniques to theorize a reliable analog neuron composed of unreliable analog neurons, or used Lipschitz regularization during training to bound variation-induced errors propagation through the layers with error compensation. In contrast to such prior work, embodiments utilize programmable active error cancellation. The cancellation operation is determined at compilation time to most efficiently and accurately run the compiled model. FIG. 8 shows the effect of variation on a 1M parameter image classification model that was trained for the analog NPU's Conv1d-based structure. To build robust large-scale analog neural networks, the analog NPU architecture of the present invention will minimize the accuracy reduction that occurs for large levels of analog variation using programmable hardware adaptation mechanisms and multiple model robustness enhancements used by the model compiler uses to optimize for the most efficient way to robustly run a given model on the architecture. These techniques are shown in FIG. 9 and described below.

FIG. 9 depicts a NN architecture data path 900 incorporating the embodied PVT and long-term drift mitigation techniques. Embodiments utilize a multi-level approach which includes (1) the addition of error correcting encoding and decoding to the weight matrices at compile time to increase model robustness during normal operation, (2) periodically cancelling errors locally using layer-level adaptation, and (3) updating a global adaptation layer 902 via a mapping 920 of measured nodes in the NN to generate IC-personalized compensation parameters 922 that are applied to the input via the adaptation layer 902 to compensate for network errors:

The error correcting encoding and decoding is performed as follows. In FIG. 9, the top path demonstrates fused operations in the pipelined analog NPU of the present invention, with error tolerance encoded at multiple levels, with two convolution layers shown for illustration (although additional layers may be provided). Delays 904/912, Weights 906/914, and ReLU 918 are compute elements that perform the desired NN operation, such as the convolutional layers (e.g., such as the grouped Conv1D in the NPU stages of FIG. 4) that perform feature extraction. Delays 904, 912 provide timing adjustment between layers to introduce programmable delays to process temporal features of signals and may compensate for propagation errors. Weights 906/914 are pretrained parameters that describe the model's operation. FIG. 9 distinguishes the weights into encoding and decoding functions that support error correction. Encoding weights 906 and decoding/encoding weights 914 provide weight modulation blocks for error coding. Encoding weights 906 applies initial encodings to inputs before the first layer, while decoding/encoding weights 914 handles inter-layer decoding/encoding to refactor weights (e.g., augmented residuals for fault tolerance). ReLU 910, 918 are rectified linear unit activation functions which are fused with convolutions for efficiency.

The periodic cancellation of errors locally using layer-level adaptation is performed by layer adapt 908, 916, which are programmable adaptation blocks per layer and which implement local loops (e.g., such as batch normalization or gain/offset trimming). This operation is described in more detail with FIG. 10.

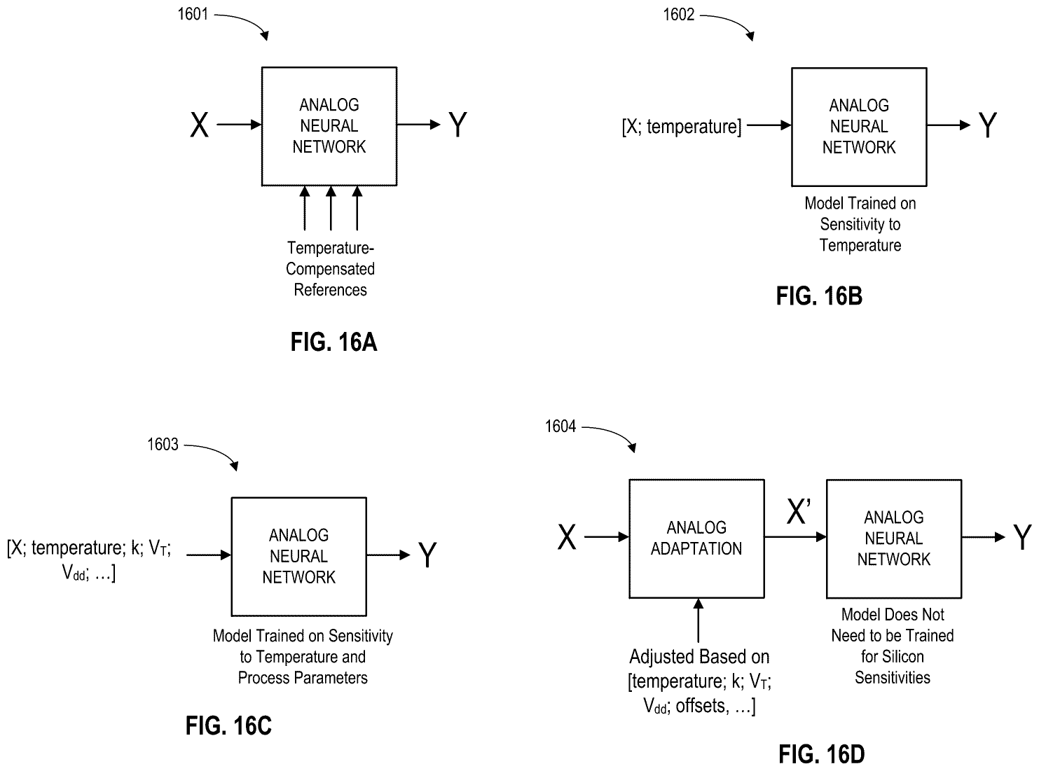

3) The global adaptation layer 902 runs during each inference, but the adaptation parameters 922 are only generated periodically to mitigate long-term drift. For example, the global adaptation layer 902 receives inputs from global adaptation parameters 922 and applies initial corrections before feeding into the first layer to re-embed the data into a form that compensates for errors in the downstream processing. As discussed above in conjunction with FIG. 2, the first layer is inserted during a top-down adaptation, acting as a compensating interface to maintain robustness across inferences. The global adaptation parameters 922 are updated periodically according to the global adaptation mapping 920. The global adaptation parameters 922 allow periodic global feedback and are run infrequently to minimize overhead while ensuring software-equivalent accuracy. Global adaptation mapping 920 includes algorithmic mapping (trained at compilation; e.g., from adversarial reprogramming or training data) that monitors NN nodes (e.g., via SMC block 1010 of FIG. 10) and generates adjustment parameters. Parameters include delays, weights and modulation factors (which may be loaded from SRAM as shown in FIG. 4, item 442) for runtime decoding. The global adaptation mapping operates on data received from the convolution layers to provide feedback for drift control (e.g. the error adaptation blocks 426/436 of FIG. 4) and may include offset measurements, reference measurements, temperature indication measurements, circuit speed measurements, etc. Correcting variations at their source is preferred when the cost (area and efficiency) can be tolerated. Correcting the overall gain and offset at each dot-product output may correct NN behavior across varying chips quite well. Examples explaining global adaptation as opposed to other adaptation approaches are described in conjunction with FIG. 16 below.

Illustrative hardware 1000 to rapidly automate “batch correction” is shown in FIG. 10, which is a functional form of the MAC array in FIG. 6 with a stimulate/measure/control (SMC) block 1010 added. One SMC block 1010 is positioned for each stream (i.e. each entry in the analog vector bus) per NPU stage. SMC blocks may perform the Layer Adapt 908/916 function in FIG. 9. An SMC block 1010 contains a target DAC (DACT) 1012 which sets the desired parameter value, and a stimulus DAC (DACs) 1014, which drives an analog bus 1020 with inputs that are used during measurement. A configurable measurement block (Meas) 1016 supports measurement of dc values (with respect to MIDRAIL or other references), gains (as deltas in response to toggled DACs values), and ramp rates. The measured parameter is compared with the target and used to adjust a successive-approximation register (“SAR”) 1018—not to digitize the measurement but to converge on the register code in the selected register which yields the desired parameter. The architecture is programmable so that the SMC block 1010 may stimulate and measure any combination of NPU operations while controlling any parameter. This gives the compiler flexibility to optimize error adaptation.

But returning to “batch correction” as an example, the control sequence would consist of loading all of the model weights, normalizing the batch gain by controlling G* (corresponds to W_{batch}* in FIG. 6) with the SAR 1018 and measuring the gain while toggling the stimulus DACs 1030 between, e.g., MIDRAIL and MIDRAIL+0.1, or some pair of vectors that has been determined to be more representative of the batch statistics. Then the SAR 1018 is connected to b* and the batch offset is adjusted. A deeper set of registers for b* 1036 and G* 1038 are included so that all functional layers can be normalized once and the batch corrections can be reused across inferences, with periodic updates to combat long-term drift. Layer-level error adaptation helps to reduce the errors in the system and normalize over long-term drift but may not be enough to achieve <5% error sensitivity for all cases.

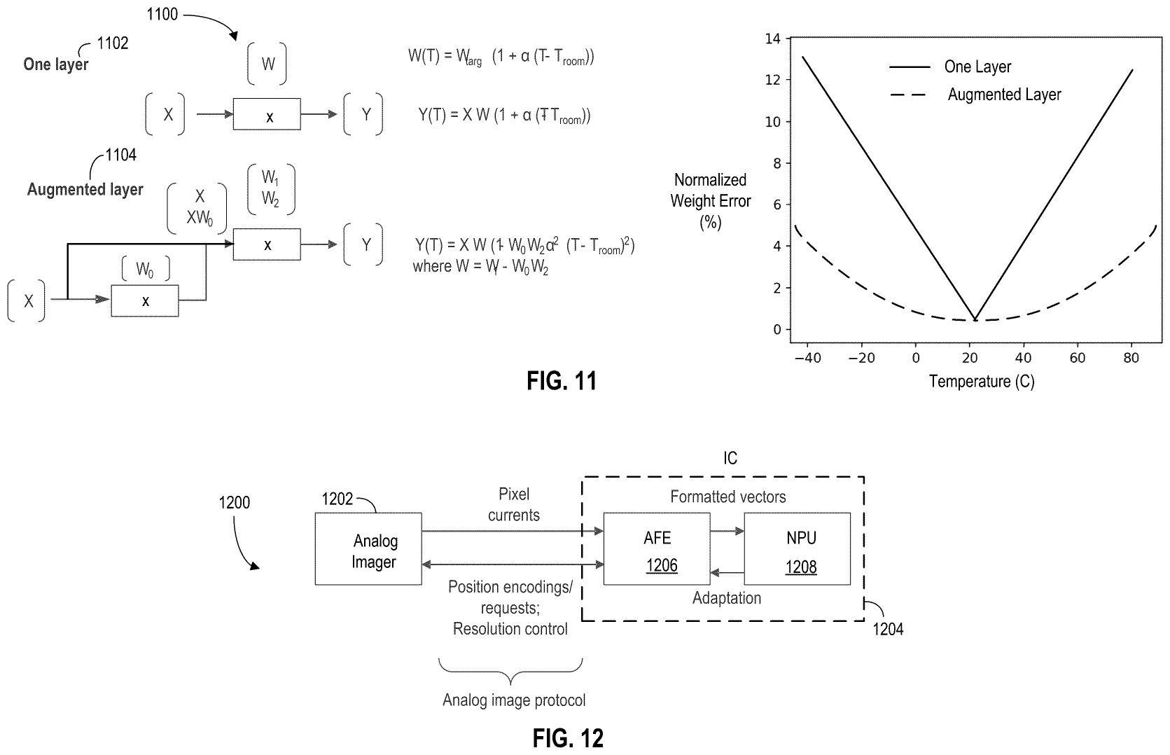

In addition to parameter manipulation, error tolerance can be built into local layer operations. These operations may be formalized in the context of error coding with limited accuracy hardware. FIG. 11 shows intuitively how layer-level encoding can correct temperature-induced errors in a linear layer. Assuming the multiplier/weight increases 0.5%/C, the normalized max error due to temperature with one layer 1102 uncompensated rises to 13%. But the weights can be partitioned across layers to compensate for inaccuracies. For example, with augmented layer 1104, the weights in a cascaded residual-type connection can be refactored to cancel the first-order temperature dependence, leaving a residual second-order dependence such that the maximum error due to temperature is reduced 3×. In this simple case, 3× more multiplies are required, but the weights have been adjusted in closed-form without retraining. In a larger neural network, the extra computation to cancel inaccuracies may already be present in the network and it's simply a matter of refactoring the weights.

For models that need more robustness than the local techniques described above provide, a global adaptation loop can also be performed. A global adaptation mapping step collects information about how the model runs on the current hardware and projects that information into parameters to use in a compensating layer. The mapping projection is trained offline with adversarial reprogramming to prompt the model to give the correct response despite hardware inaccuracies. The mapping runs periodically and the resulting global adaptation parameters are stored in SRAM and used by the global adaptation layer for each inference. Measurements of network characteristics are performed using an SMC block (item 1010 of FIG. 10) and the mapping is performed by the analog NPU through reprogramming—the SMC block 1010 can be used to exhaustively trim every parameter before doing the mapping since this step occurs rarely and thus the overhead can be tolerated.

Features of adaptation approaches pursuant to some embodiments are shown in FIGS. 16A-16D. FIGS. 16A-B first illustrate the concept only for neural network temperature dependence; then FIGS. 16C-D illustrate the concept for more general error cancellation. FIG. 16A depicts a traditional compensation approach 1601 to manage an analog NN's temperature variation. In this approach, temperature compensated reference data control the analog NN to mitigate the temperature dependence at the source such that Y=f(X) through the network regardless of temperature. Sufficiently accurate temperature compensation of analog NNs may reduce the NN efficiency, so it may be desirable to achieve temperature independence without fully compensating for temperature dependence within the network. FIG. 16B depicts a basic approach 1602 to achieve temperature independence without fully compensating temperature within the network. In the global adaptation approach 1602, the NN may be allowed to vary with temperature, but the temperature might be provided as an additional input and the model running in the NN may be trained to adjust its output based on the temperature input such that the output (Y=f(X)) is insensitive to temperature.

Now considering all potential sources of error, FIG. 16C shows an approach 1604 which generalizes beyond the temperature example to process variation and supply voltage variations. The NN's native process parameters and supply voltage might be measured and supplied as additional inputs to the NN (shown as inputs [X; temperature; k; V_{T}, V_{dd} . . . ]). The NN may be trained such that Y=f(X) regardless of how those other parameters vary. However, in some situations it is not ideal to change the model's input dimensions by appending all of these different process parameters. It is generally also not ideal to retrain the model to understand how to compensate for these variations. These nonideailities may be overcome through use of an adaptation approach as shown in FIG. 16D, in which the weights and biases of the adaptation layer are adjusted based on run-time characteristics such that Y=f(X) by generated X′ that compensates for nonidealities in the analog NN. The analog NN model is unaware of error statistics of the circuitry that it runs on but offline adversarial training has identified how to use observations of the analog NN errors to project X into X′ to obtain the desired operation with low error.

Pursuant to some embodiments, the analog NPU system of the present invention is designed to interface directly with analog imagers. Interfacing directly to the sensor unlocks a key value for analog inferencing: the sensor data can be processed directly without the overhead of an ADC. Additionally, vision systems traditionally include several image processing steps to transform the imager output into an RGB space consistent with human perception. However, many of these steps are unnecessary for trained computer vision systems—[40] found that only gamma correction and demosaicing are needed. FIG. 12 shows a system where an analog imager 1202 connects directly to the analog neural network IC 1204. An analog front-end (AFE) 1206 in the IC 1204 prepares the signal for the NPU 1208—essentially applying nonlinear gamma correction and framing the pixels as an input vector. The pixel currents are scanned out of the analog imager. The AFE 1206 may be scalable to support varying numbers of rows scanned out in parallel—32 rows may be used to more easily frame 16×16 pixel blocks for patch embedding input to the NPU 1208. Some AFE 1206 embodiments may accept pixel currents from a passive pixel sensor (PPS).

An AFE embodiment 1206 for PPS is shown in FIG. 13. An analog imager 1310 is provided in which rows (shown for simplicity as row₀ and row₁) are scanned out in parallel bundles of currents. The analog front-end (AFE) 1320 has parallel current-mode gamma correction blocks 1322 that are split out into a vector of sample-and-holds which may form a vector per pair of rows, forming a single row of RGB pixels that can be saved to short-term memory or immediately processed by the NPU. Dark current subtraction and correlated double-sampling may be included in the AFE 1320 or in the NPU as needed—e.g., NPU global error adaptation may be performed using pixel reset levels as stimuli to cancel the imager's variations as well. Additional system embodiments may input digital sensor data to the analog NPU. For example, the AFE may be augmented with a digital camera interface (such as MIPI CSI) or parallel interface to accept digital data.

The proximity of the analog processor to the sensor opens opportunities for tight adaptation loops which may have multiplicative effects on the system metrics. Embodiments include adaptation schemes to improve accuracy versus energy tradeoffs in the benchmarks, including sensor mechanisms (exposure time, downsampling (e.g. foveation)), interface mechanisms (gamma value, color balance, global/regional brightness), and model mechanisms (adaptive resolution, early exit from unnecessary computation).

A demonstration system 1400, shown in FIG. 14 may be used with some embodiments to develop applications and measure performance for different benchmarks. The demonstration system 1400 can process live imager outputs or stream artificial stimuli into the NPU device-under-test (“DUT”) IC. Power consumption can be monitored to show system power efficiency. A simple API allows new models to be compiled and loaded through a USB interface. In general, the demonstration system 1400 may include a USB interface over which models may be loaded onto the demonstrator PCB 1402 from an external computer running Python 1404. The demonstrator PCB 1402 may be configured with a microcontroller (“MCU”) or an FPGA 1406, an imager 1408 an NPU device under test 1410 and a power monitor 1412. Those skilled in the art, upon reading the present disclosure, will appreciate that other components may also be provided to test and configure the demonstration system 1400. Although specific hardware and data configurations have been described herein, note that any number of other configurations may be provided in accordance with some embodiments of the present invention (e.g., some of the information associated with the databases described herein may be combined or stored in external systems).

The present invention has been described in terms of several embodiments solely for the purpose of illustration. Persons skilled in the art will recognize from this description that the invention is not limited to the embodiments described but may be practiced with modifications and alterations.

We claim:

1. An analog neural processing unit (NPU) comprising:
an interface configured to receive raw sensor data and perform preprocessing to generate analog vectors;
a full-duplex analog vector bus coupled to the interface for routing the analog vectors; and
a plurality of pipelined analog NPU stages coupled to the analog vector bus, dynamically configured to perform fused neural network operations on the analog vectors and ultimately output a final inference based on the raw analog sensor data.

2. The analog NPU of claim 1, wherein the interface is an analog front end (AFE).

3. The analog NPU of claim 1, wherein the interface is a digital camera interface.

4. The analog NPU of claim 3, wherein the digital camera interface is one of (i) a MIPI CSI interface, and (ii) a parallel interface.

5. The analog NPU of claim 1, further comprising:
a short-term sample-and-hold (S/H) buffer and a long-term S/H buffer, each coupled to the analog vector bus, for caching the analog vectors and intermediate features.

6. The analog NPU of claim 1, wherein the plurality of pipelined analog NPU stages each further comprise a grouped convolution block, an activation block, a pooling block, a fully connected linear or cross-product block, and a softmax block.

7. The analog NPU of claim 1, further comprising:
one or more error adaptation blocks coupled to each of the plurality of pipelined analog NPU stage for programmable layer-level normalization and global error compensation.

8. The analog NPU of claim 1, further comprising:
a static random-access memory (SRAM) for storing compressed neural network parameters and adaptation schedules;
a decoder coupled to the SRAM to decompress the parameters into decoded parameters fed to the plurality of pipelined analog NPU stages;
a control state machine (CSM) coupled to the decoder and the error adaptation blocks to schedule operations and trigger adaptations; and
an interface, coupled to the CSM for external model loading, with bypass capability;
a clock generator coupled to the CSM to provide timing control; and
a power management component coupling power supply domains and references to the analog components for variation-tolerant operation.

9. The analog NPU of claim 8, wherein the interface is a quad serial peripheral interface (QSPI).

10. A method for compiling a model for execution on an analog neural processing unit (NPU), the method comprising:
receiving the model;
lowering the model by remapping the model architecture and re-embedding the data representation;
executing an error tolerance process to encode feedforward error correction into model layer parameters and to schedule local error adaptation to run as part of the compiled model operation;
executing a compression step to recover accuracy loss by retuning the compiled model;
executing an adaptation step to converge on an adaptation mapping to control an adaptation layer of the compiled model; and
outputting the compiled model, wherein the compiled model includes (i) compressed model parameters, (ii) a codebook to enable decompression of the compressed model parameters, and (iii) sequencing instructions for performing model operation and dynamic error correction.

11. The method of claim 10, wherein the model is a pre-trained digital neural network.

12. The method of claim 11, wherein the pre-trained digital neural network is a ResNet convolutional neural network optimized for binary classification.

13. The method of claim 10, further comprising:
loading the compiled model into a memory of an analog NPU;
executing the compiled model by the analog NPU.

14. A system, comprising:
an interface configured to receive raw imaging data and perform preprocessing to generate analog vectors;
a full-duplex analog vector bus coupled to the interface for routing the analog vectors;
a plurality of pipelined analog NPU stages coupled to the analog vector bus, dynamically configured to perform fused neural network operations on the analog vectors and ultimately output a final inference based on the raw imaging data; and
a battery, the battery supplying power to the interface, the full-duplex analog vector bus, and the plurality of pipelined analog NPU stages.

15. The system of claim 14, wherein the raw imaging data is received from a digital imaging device.

16. The system of claim 14, wherein the preprocessing to generate analog vectors includes processing to apply gamma correction and demosaicing to frame pixel values into analog vectors.

17. The system of claim 14, further comprising:
a communications device, the communications device configured to transmit a detection signal to an external device based at least in part on the final inference.

18. The system of claim 14, wherein the fused neural network operations include feature extraction and class probability operations.

19. The system of claim 14, wherein the fused neural network operations implement a ResNet convolutional neural network variant optimized for binary classification.

20. The system of claim 19, wherein the final inference is a binary classification of the presence or absence of an object.
